(19) United States
(12) Patent Application Publication
(10) Pub. No.: US 2003/0191814 A1
(43) Pub. Date: Oct. 9, 2003

(54) Personalization in a wireless portal server

(76) Inventor: Luu Tran, Santa Clara, CA (US)

Correspondence Address: WAGNER, MURABITO & HAO LLP, Third Floor, Two North Market Street, San Jose, CA, 95113, US

(21) Appl. No.: 10/116,430

(22) Filed: Apr. 3, 2002

(51) Int. Cl. G06F 15/16

(52) U.S. Cl. 709/217

(57) ABSTRACT

Embodiments of the present invention relate to a method and apparatus that allow for personalization of services provided to wireless-device users. The portal server is communicatively coupled with at least one wireless network for sending and receiving communications over the wireless network. The portal server is also communicatively coupled to service providers for providing content to wireless-network users over channels of the portal server. An interface is provided that allows for communicating with service providers. Questions are specified that can be used for obtaining information about wireless-device users. Upon receiving a request from a service provider that includes at least one question and that identifies a wireless-device user, a response to the question is determined by the wireless portal server. The response is then sent to the requesting service provider.

### FIELD OF THE INVENTION

The present invention relates to the field of communication apparatus and methods. Embodiments of the present invention relate to apparatus and methods for personalization using a portal server.

### BACKGROUND OF THE INVENTION

A portal server provides means for users to access multiple sources of information and services via the Internet. More particularly, service providers deliver information to the client via “channels” that are accessed through the portal server.

Users contact the portal server using a client program (e.g., the requesting program associated with the user). Typically the client program is a web browser or other program operable on the client's computing device. The client program requests web pages (e.g., HTML pages or files) from the portal server. The portal server then provides the requested web pages, either from its own data storage or through access to resources of service providers.

The services offered to Internet users have recently grown in complexity and sophistication. For example, there has been a growing trend to more particularly target advertising to those individuals who are most likely to favorably respond. In addition, to keep users interested in a site or a service, the site or service must hold the user's interest and be easy to use.

One way to facilitate highly targeted advertising and keep a user's interest in a site or a service is by making the site or service easy to use through personalization. Personalization involves determining the anticipated needs of a user and tailoring the services offered to that user according to the user's anticipated needs.

Prior art methods for personalization typically involve hiring an individual or group of persons to analyze data to determine whether a user or a group of users would be interested in a product or service. However, this is expensive and time consuming.

The use of wireless communication devices (e.g., cellular telephones, paging devices and Personal Digital Assistants (PDAs)) has increased dramatically in recent years. As a result, there is a need for providing a mechanism whereby the users of wireless devices can access the Internet.

Accordingly, there is a need for a way to personalize services offered by service providers. In addition, there is a need for a method and apparatus that meet the above needs and that provide personalization for users of wireless devices. The method and apparatus of the present invention provide a solution to the above needs.

### SUMMARY OF THE INVENTION

The method and apparatus of the present invention use a portal server for providing wireless-device users access to the Internet. More particularly, embodiments of the present invention provide wireless-device users access to information and services offered by service providers. The method and apparatus of the present invention allow for personalization of services provided by service providers for wireless-device users.

A portal server is disclosed that is communicatively coupled with at least one wireless network. The portal server is also communicatively coupled to service providers for providing content to wireless-network users over channels of the portal server. The portal server is operable for providing a personalization service for personalization of services provided by the service providers.

A method is disclosed for providing personalization services using a portal server. First, an interface is provided that is coupled to the portal server. The interface allows for communicating with service providers.

Questions are specified that can be used for obtaining information about wireless-device users. In one embodiment, a wireless application interface specification is issued and is frequently updated that specifies questions that can be asked about a wireless-device user.

Upon receiving a request from a service provider that includes at least one question and that identifies a wireless-device user, a response to the question is determined. The response is then sent to the requesting service provider.

Information provided by wireless-device users (e.g., static preference data) and data provided by service providers can be used for determining the response to the question. In addition, session data from communication sessions with the wireless-device user can also be used for determining the response to the question. In addition, location data that indicates current and past locations of the wireless-device user can also be used for determining the response to the question.

By carefully controlling the questions that can be asked, private information about the wireless-device user is not divulged. However, all available private and non-private information relating to the wireless-device user can be used in the determination of the response. Accordingly, the method and apparatus of the present invention allow for personalization while maintaining private confidential information relating to a wireless-device user.

Accordingly, the method and apparatus of the present invention provide a way to personalize services offered by service providers. In addition, the method and apparatus of the present invention provide personalization for users of wireless devices.

### BRIEF DESCRIPTION OF THE DRAWINGS

The operation and components of this invention can be best visualized by reference to the drawings.

FIG. 1 illustrates a wireless portal server network in accordance with one embodiment of the present invention.

FIG. 2 illustrates an exemplary computer system in accordance with one embodiment of the present invention.

FIG. 3 illustrates functional components of a wireless application environment in accordance with one embodiment of the present invention.

FIG. 4 is a flow chart that illustrates a method for providing personalization services using a wireless portal server in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention. At times, concepts disclosed in this discussion of embodiments of the present invention will be made more readily apparent in reference to the Figures.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic information capable of being stored, transferred, combined, compared, and otherwise manipulated in a computer system. It has proven convenient at times, principally for reasons of common usage, to refer to this information as transactions, bits, values, elements, symbols, characters, fragments, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “determining,” “sending,” “storing,” “providing” or the like, refer to actions and processes of a computer system or similar electronic computing device. The computer system or similar electronic computing device manipulates and transforms data represented as physical (electronic) quantities within the computer system memories, registers or other such information storage, transmission or display devices.

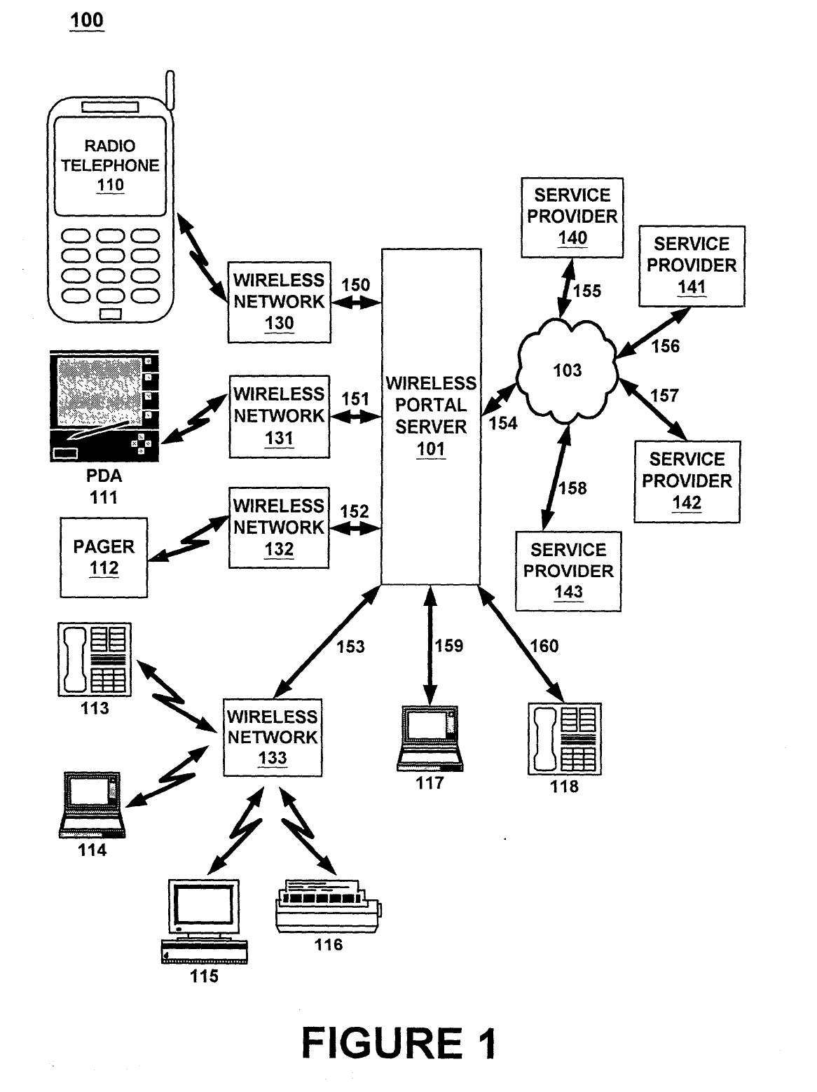

FIG. 1 shows an exemplary wireless portal server network 100 that includes wireless portal server 101. In the present embodiment, wireless portal server 101 is a portal server that provides services to wireless-device users. In one embodiment, wireless portal server 101 is a portal server that only provides services to wireless-device users. However, in one embodiment, these wireless-device users can obtain services from and communicate with wireless portal server 101 using both wireless communication methods and non-wireless communication methods.

In the present embodiment, wireless portal server 101 provides content or “channels” from service providers 140-143. These channels are made available to wireless-device users through the use of communication devices 110-116 by communication through wireless networks 130-133. In one embodiment, channels are also made available to wireless-device users through communication devices 117-118 that are not wireless devices and that are not coupled to any wireless network.

Communication devices 110-116 include wireless-communication devices and non-wireless communication devices that are wirelessly linked to portal server 101. Continuing with FIG. 1, examples of wireless-communication devices that are illustrated include radio telephone 110, Personal Digital Assistant (PDA) 111, pager 112, telephone 113, portable computer 114, desktop computer 115 and facsimile device 116. It is appreciated that communication devices 110-116 are exemplary and that other types of communication devices could also be wirelessly linked to portal server 101.

Radiotelephone (e.g., a cellular telephone 110) is coupled to wireless portal server 101 via wireless network 130. More particularly, radiotelephone 110 is wirelessly coupled to wireless network 130. Wireless network 130 is coupled to wireless portal server 101 by the communication pathway indicated by arrow 150.

Personal Digital Assistant (PDA) 111 is coupled to wireless portal server 101 via wireless network 131. More particularly, PDA 110 is wirelessly linked to wireless network 131. Wireless network 131 is coupled to wireless portal server 101 by the communication pathway indicated by arrow 151.

Pager 112 is coupled to wireless portal server 101 via wireless network 132. More particularly, pager 112 is wirelessly linked to wireless network 132. Wireless network 132 is coupled to wireless portal server 101 by the communication pathway indicated by arrow 152.

Continuing with FIG. 1, wireless network 133 is coupled to wireless portal server 101 by the communication pathway indicated by arrow 153. The communication devices wirelessly linked to wireless network 133 include telephone 113, portable computer 114, desktop computer 115 and facsimile device 116. Devices 113-116 can be stand-alone communication devices or can include a radio modem or other similar device for providing wireless communication abilities.

Communication pathways 150-153 couple wireless networks 130-133 to portal server 101. Communication pathways 154-158 couple wireless portal server 101 to the Internet and to service providers 140-143. Communication pathways 150-158 can include the Internet and any of a number of different communications systems such as the Plain Old Telephone System (POTS), wireless communication systems (e.g., cellular telephone communication systems and paging systems) and may include one or more Local Area Network (LAN), Wide Area Network (WAN), or other communication systems, and may use Ethernet, Transmission Control Protocol/Internet Protocol (TCP/IP), Hypertext Transfer Protocol (HTTP) or other communication protocols.

In the present embodiment, wireless portal server 101 is coupled to communication devices 117-118 by the communication pathways indicated by arrows 159-160. More particularly, wireless portal server 101 is coupled with portable computer 117 by the communication pathway indicated by arrow 159. Wireless portal server 101 is coupled with telephone 118 by the communication pathway indicated by arrow 160. In the present embodiment communication pathways 159-160 are non-wireless communication pathways such as conventional telephone land line. Communication pathways 159-160 can include the Internet and any of a number of different communications systems such as the Plain Old Telephone System (POTS), and may include one or more Local Area Network (LAN), Wide Area Network (WAN), or other communication systems, and may use Ethernet, Transmission Control Protocol/Internet Protocol (TCP/IP), Hypertext Transfer Protocol (HTTP), wireless access protocol (WAP) or other communication protocols.

Though the embodiment of FIG. 1 shows service providers 140-143 to be linked to wireless portal server 101 via the Internet 103, one or more of service providers 140-143 could also be directly linked to wireless portal server 101 through a communication link that does not include the Internet. Similarly, some or all of wireless communication devices 110-116 could be directly wirelessly linked with portal server 101.

In the present embodiment, wireless portal server 101 provides a wireless application environment that specifies an environment that allows service providers 140-143 and operators of wireless networks 130-133 to build applications and services that can reach a wide variety of different platforms (e.g., communication devices 110-118). Requirements for communicating and providing services within the wireless application environment are specified, allowing for communication between wireless-device users and providers of services useful to wireless-device users.

Wireless portal server 101 of FIG. 1 is disclosed to provide communication for wireless-communication-device users when wireless-communication-device users are operating wireless-communication devices. However, those wireless-communication-device users can also communicate using communication devices that are not wireless-communication devices and using communication pathways that do not include wireless communication pathways. Thereby, wireless-device users having multiple communication devices can use all available communication devices for accessing services from portal server 101.

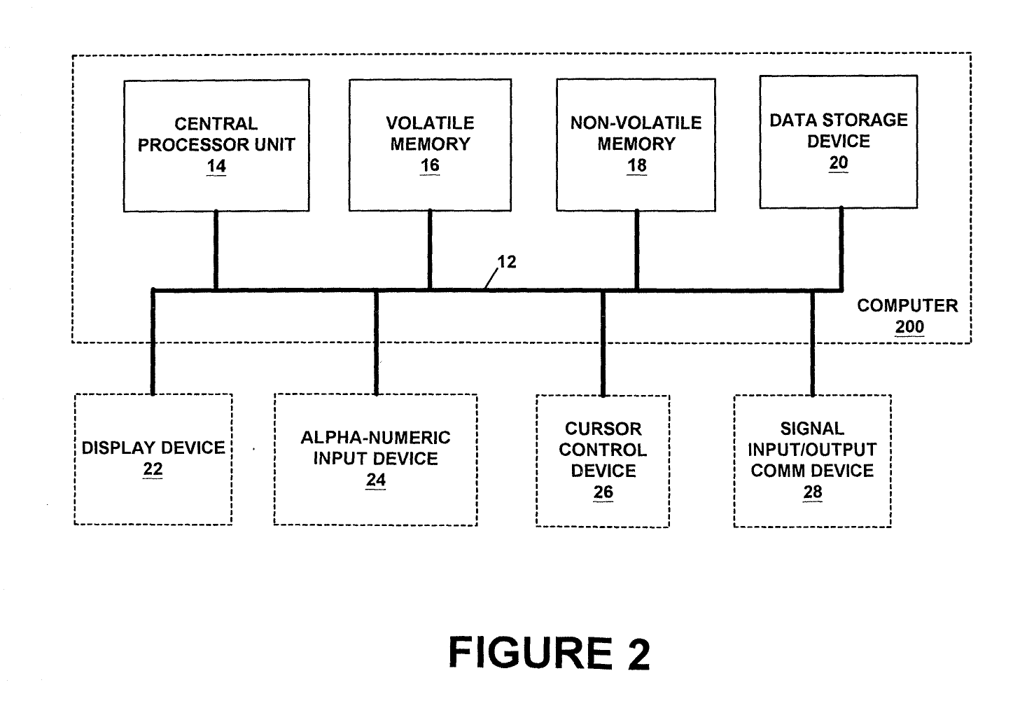

FIG. 2 shows an exemplary computer system 200 used by embodiments of the present invention. In general, computer system 200 of FIG. 2 includes an address/data bus 12 for communicating information and one or more central processor unit 14 coupled with bus 12 for processing information and instructions. Central processor unit 14 may be a microprocessor or any other type of processor. Computer system 200 also includes data storage features such as a computer usable volatile memory unit 16 (e.g., random access memory, static RAM, dynamic RAM, etc.) coupled with bus 12 for storing information and instructions for processor(s) 14.

Continuing with FIG. 2, optional signal input and output device 28 is coupled with bus 12 for enabling system 200 to interface with other electronic devices. In one embodiment of the present invention, input and output device 28 is a serial communication port, but could also be any number of well known communication standards and protocols, e.g., Universal Serial Bus (USB), Ethernet, FireWire (IEEE 1394), parallel, small computer system interface (SCSI), infrared (IR) communication, Bluetooth wireless communication, modem, wireless modem, etc.

Computer system 200 also includes a data storage device 20 (“disk subsystem”) such as a magnetic or optical disk and disk drive coupled with the bus 12 for storing information and instructions. In the present embodiment, data storage device 20 includes one or more removable magnetic or optical storage media such as disk drives, magnetic tape, CD's etc.

Optionally, computer system 200 can include a display device 22 that is coupled to bus 12 for displaying graphics and/or video. It should be appreciated that optional display device 22 can be a cathode ray tube (CRT), flat panel liquid crystal display (LCD), field emission display (FED), or any other display device suitable for displaying video and/or graphic images and alphanumeric characters recognizable to a user. Furthermore, system 200 can include an optional alphanumeric input device 24 including alphanumeric and function keys coupled to the bus 12 for communicating information and command selections to the central processor(s) 14.

Additionally, the computer system 200 of FIG. 2 can include an optional cursor control device 26 coupled to the bus 12 for communicating user information and command selections to the central processor(s) 14. Cursor control device 26 allows the computer user to dynamically signal the two-dimensional movement of a visible symbol (pointer) on a display screen of display device 22. Many implementations of the cursor control device are known in the art including a trackball, mouse, joystick or special keys on alphanumeric input device 24 capable of signaling movement of a given direction or manner of displacement. It is to be appreciated that the cursor control 26 also may be directed and/or activated via input from the keyboard using special keys and key sequence commands. Alternatively, the cursor may be directed and/or activated via input from a number of specially adapted cursor directing devices.

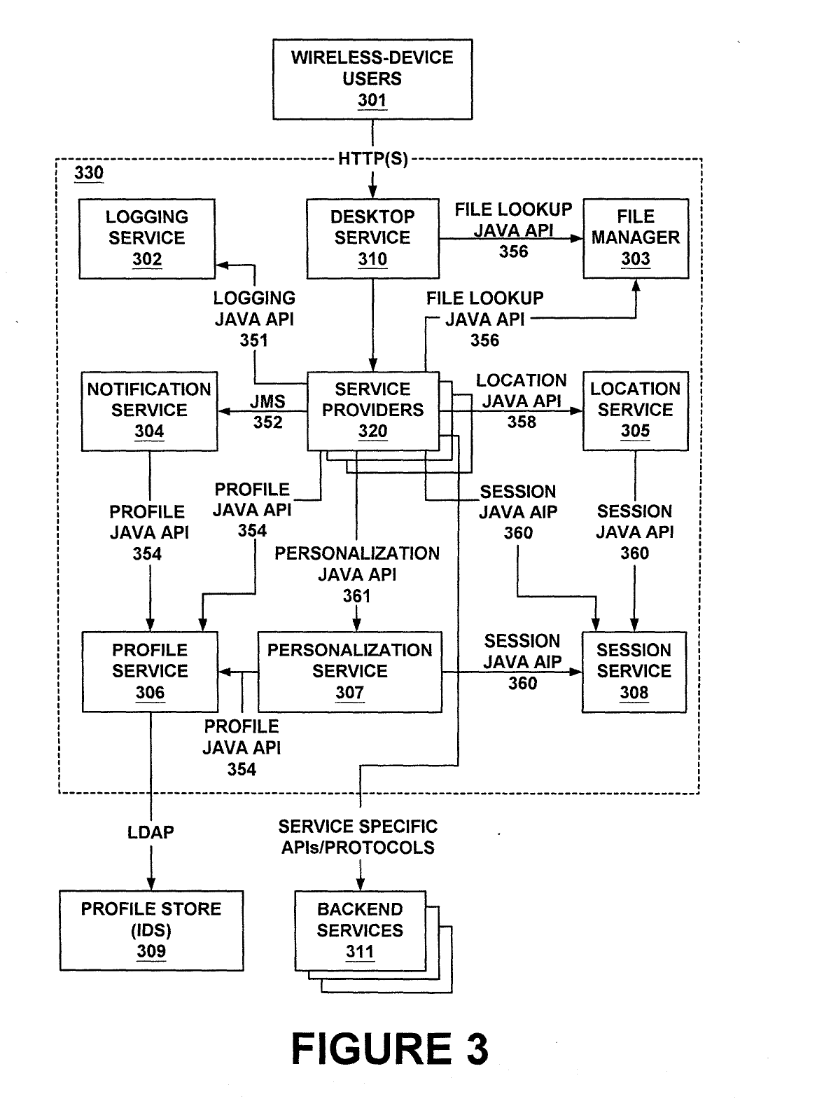

FIG. 3 shows a wireless application environment 330 that allows service providers 320 (e.g., service providers 140-143 of FIG. 1) to provide to wireless-device users the dynamic content that users seek when using the Internet. In one embodiment all of the components of wireless application environment 330, except for service providers 320, are implemented as one or more software program (e.g., wireless portal server 101 of FIG. 1) operable on a computer system (e.g., computer system 200 of FIG. 2). In another embodiment some of the elements of wireless application environment 330 are distributed across multiple computer systems that are communicatively linked.

Continuing with FIG. 3, wireless-device users 301 access the wireless application environment 330 to utilize services and information from service providers 320. Service providers 320 include service providers that provide channels of content (e.g., service providers 140-143 of FIG. 1) and includes service providers that provide other types of services such as, for example, providers of communication services (e.g., the operators of communication networks 130-133 of FIG. 1). Service providers 320 can also include other persons or entities that contribute information and/or services to wireless application environment 330.

Wireless portal environment 332 also includes logging service 302 which communicates with the provider 320 via logging API (Application Program Interface) 351. In this embodiment of the present invention, logging API 351 is implemented as a Java API. Logging API 351 can be implemented in many different physical platforms within a network.

Session service 308 acquires and stores the information peculiar to each communication session, such as what information the user wants to receive during the communication session and the session identification number. Session information is dynamic and primarily includes information that is only stored for short periods of time. Location service 305 communicates with session service 308 via session interface 360. In one embodiment, session service 308 stores location information for use by location service 305.

Profile service 306, via profile interface 354, supplies wireless-device user related information including, for example, static preferences and information peculiar to the wireless-device user's access device (e.g., display size and bandwidth capability). Profile service 306 acquires its profile information from profile store 309 through the use of an LDAP (Lightweight Directory Access Protocol) API. LDAP provides a simple protocol that allows the access and search of directories containing information that is often stored on a variety of incompatible systems.

Personalization service 307 supplies a wide range of user-related information. The user's name and various identity numbers, the user's preferences in a wide array of consumer selections can all be supplied by the personalization service. Profile service 306 and personalization service 307 communicate with each other and with service providers 320 via a profile interface 354 and personalization interface 361.

As discussed above, each service communicates with a provider in accordance with the needs that develop in providing information and services to wireless-device user 301. Every wireless-device user 301 differs in the type of device used to access a wireless network, in the personalized way in which the user prefers to receive information, in the information the user is looking for in any given access session, and in the services the user wants to have made available. Each provider responds by complying with the users' preferences that are stored and can be changed as required by the wireless-device user.

Each of service providers 320 obtains the particular needs of a wireless-device user's communication device and preferred services from profile service 306. The user's desktop preferences, what items the user wants displayed at any given time, are supplied from the desktop service 310. Desktop service 310 couples with file manager 303 and service providers 320 to provide requested services and/or information to wireless-network users 301. User location knowledge is provided to service providers 320 by a location service, 305 that acquires user location information and stores it in anticipation of a query by a provider. Backend services 311 provide additional resources for the wireless application environment.

In one embodiment notification service 304 is the functional component that is primarily operable to couple communications to wireless-device users 301. Notification service 304 is accessed by providers 320 through interface 352 which is a Java Messaging Server (JMS) interface. In one embodiment, profile service 306 is operable to receive and store data identifying communication devices that can be used to couple communications to a wireless-network user (communication device data). In one embodiment communication device data is stored in profile store 309 for access by profile service 306.

In one embodiment, communication-device data is entered in the wireless-network user's user profile (profile service 306). More particularly, in one embodiment, the wireless-network user 301 accesses (through the desktop service 310) web pages that are forms requesting information relating to communication devices that can be used to reach the wireless-network user 301. The wireless-network user then fills out the forms, indicating the type of device, any associated phone number, or other information necessary to communicate with the communication devices. This information, referred to hereinafter as “communication device data,” can include data identifying the wireless-network user's wireless-communication devices and non-wireless communication devices as well.

When a wireless-device user enters data identifying two or more communication devices, the user is allowed to indicate preferences between the communication devices. In one embodiment, the wireless-device user can indicate on the forms that indicate communication device data preferences between communication devices. Alternatively, preferences between communication devices are indicated on separate web pages that are specifically designed for the entry of preferences.

When the wireless-network user indicates a preference between communication devices, the preference is stored as “preference data”. In the embodiment shown in FIG. 2, the preference data is stored in data storage device 20. In the embodiment shown in FIG. 3, the preference data is stored in profile service 306. In one embodiment, preference data is stored in profile store 309 for access by profile service 306.

In one embodiment, the preference data includes preferences relating to the source of the communication, the type of communication device used to send the communication and/or the indicated priority of the communication. For example, the wireless-network user can indicate that all incoming email messages are to go to his desktop computer unless the incoming email is from his boss. Messages from his boss can be routed to his cellular telephone. Similarly, the wireless-device user can indicate that voice communications have a higher priority than email messages, or that messages from a particular communication device have a higher priority.

The preference data can also include static data relating to the wireless-device user. For example, preference data can include the wireless-device user's name, address, age and any other characteristics that the user wishes to enter.

When a communication is received at the wireless portal server (that indicates a wireless-network user that is to receive the communication) the portal server automatically determines the protocol for sending the communication to the wireless-network user and sends the communication to the wireless-network user. In the present embodiment the communication device data and the preference data is used to determine the protocol for sending the communication to the wireless-network user. In the embodiment shown in FIG. 3, notification service 304 is operable to determine the communication device that is to be used to send the communication to the wireless-network user 301. In one embodiment, notification service 306 obtains the communication device data and the preference data from profile service 306 and determines the protocol that is to be used by analysis of the communication device data and the preference data.

In the present embodiment, the message is automatically formatted in a format that is suitable to the communication device that is to receive the message and that is suitable for transmission through any communication networks that will convey the message to the wireless-network user. In one embodiment, message conversion is automatically performed using a computing device such as computer system 200 of FIG. 2. Thus, for example, if a large text message is received that is to be coupled to a communication device having a limited-size display, the text message is converted into the required format. Similarly, if a text message is received and the receiving communication device does not provide for textual display, the text message is converted to the appropriate format. For example, if a text message is to be sent to a radiotelephone that does not have textual display capabilities, the text message is converted into a voice message that is then sent. Similarly, if a text message is received that is to be sent to a facsimile device, the message is reformatted into a format that can be received by the particular facsimile device.

In one embodiment the notification service can be used by other programs operable within either the portal server or within the wireless application environment for communicating with the wireless-device user. For example, a calendar program operable on server 101 of FIG. 1 or operable on one of communication devices 110-118 can automatically send a communication to the wireless-device user (e.g., notification of an upcoming meeting or event).

In one embodiment, each of services 302-308 are available to service providers 330 through API's 351-354, 356, 358 and 360-361. Though personalization service 307, logging service 302, notification service 304, profile service 306, desktop service 310, session service 308, file manager 303 location service 305 and session service 308 are shown as separate functional blocks within the wireless application environment, individual services may actually be integrated with other services.

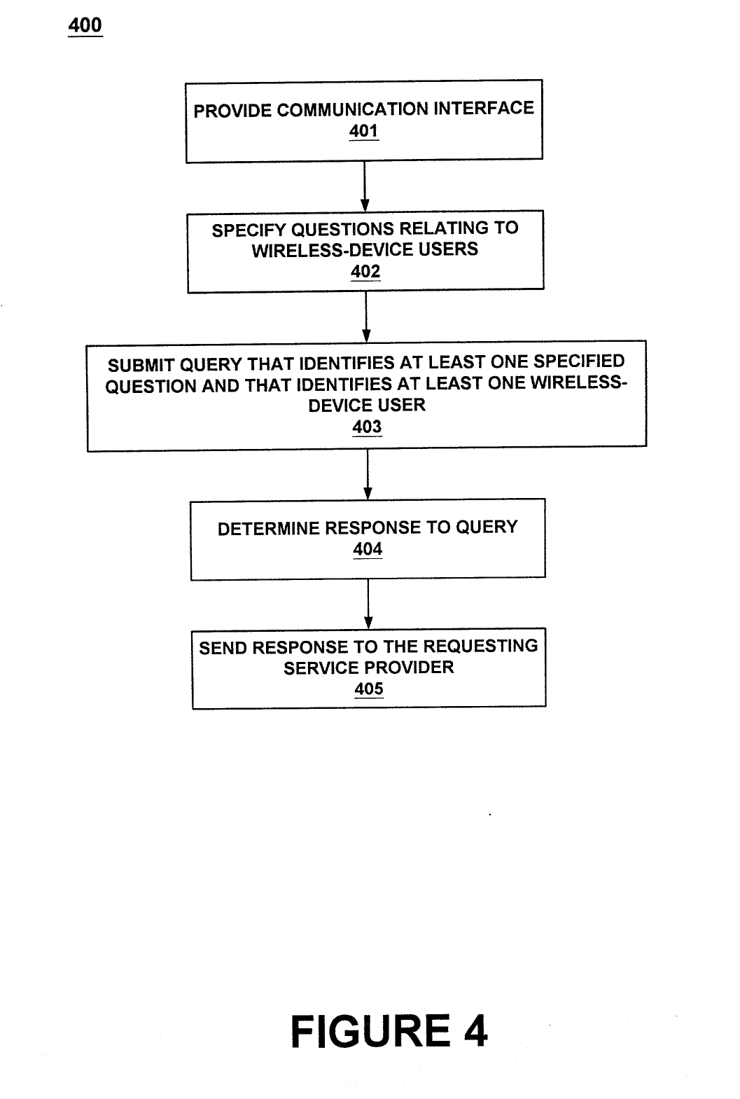

FIG. 4 illustrates a computer-implemented method 400 for providing personalization services. In one embodiment, prior to performing the steps of method 400 or during some or all of the steps of method 400, wireless-device clients are detected and authenticated. Client detection is described in greater detail in U.S. patent application Ser. No. 09/929,477, filed Aug. 13, 2001 entitled Extensible Client Aware Detection in a Wireless Portal System, naming Luu Tran et al. as inventors, which is hereby incorporated by reference in its entirety. Client authentication is described in greater detail in U.S. patent application Ser. No. 09/929,476, filed Aug. 13, 2001 entitled Client Aware Authentication in a Wireless Portal System, naming Luu Tran et al. as inventors, which is hereby incorporated by reference in its entirety.

Referring now to step 401 of FIG. 4, an interface is provided for communicating with service providers. In one embodiment, this interface is provided by wireless portal server 101 of FIG. 1 so as to allow for communication with service providers 140-143. In the embodiment shown in FIG. 1, the interface also allows for communication with wireless networks 130-133 and with any other service providers. In the embodiment shown in FIG. 3, the interface for communicating with service providers is shown as personalization interface 361. In the present embodiment, personalization interface 361 is a Java Application Program Interface (API).

Continuing with FIG. 4, as shown by step 402, questions relating to wireless-device users are specified. In one embodiment, the questions are included in the specifications of the wireless application protocol. In the present embodiment, the specified questions are dynamic. That is, they constantly evolve to meet the needs of providers and to take advantage of technological capabilities of the wireless application environment. This provides an extensible environment that changes to meet the needs of wireless-device users and the needs of service providers.

Queries are submitted as shown by step 403 of FIG. 4 that identify at least one question and that identify at least one wireless-device user. In the embodiment shown in FIG. 1, queries are submitted to wireless portal server 101. In the embodiment shown in FIG. 3, questions are submitted to personalization service 307 via personalization interface 361. Questions can be submitted by providers 320 (e.g., service providers 140-143 of FIG. 1 and operators of wireless networks 130-133. In one embodiment, to maintain security and privacy of wireless-device users 301, access is restricted to those service providers 320 who maintain specified security precautions.

Continuing with step 403 of FIG. 4, each query must identify at least one question. In the present embodiment, the question must be one of the questions specified in step 402. Each query must also identify at least one wireless-device user (e.g., one of wireless-device users 301 of FIG. 3).

Referring now to step 404 of FIG. 4, a response to the query is determined. In the embodiment shown in FIG. 1, responses to queries are determined by wireless portal server 101. In the embodiment shown in FIG. 3, responses to queries are determined by personalization service 307. In one embodiment, a computer program, (e.g., a program that performs the functions of personalization service 307 of FIG. 3) that is operable on a computer system (e.g., computer system 200 of FIG. 2) is operable to determine a response to the query. The response can utilize any and all information available within the wireless application environment. Thus, in the embodiment shown in FIG. 3, any and all information available from services 302-308 can be used for determining a response. Also, in one embodiment, information available through backend services 311 can be used for determining a response.

In one embodiment, personalization service 307 is operable to determine a response using information from session service 308 and profile service 306. Thereby, personalization service 307 can obtain preference data (e.g., static preference data, preference data regarding communication devices and any other preference data provided by service providers 320.

In the present embodiment, the response provided in step 404 of FIG. 4 is predictive. That is, the response predicts likely future behavior based on information available pertaining to the particular wireless-device user indicated in the query.

In one embodiment, providers 320 provide information to profile service 306 that is relevant to the questions specified in step 402 on a regular basis. This information is then used for determining responses. For example, when a wireless-device user requests a stock quote, profile service 306 may have preference data that indicates the stock quotes that are most likely to be desired by that particular wireless-device user. These preferences that relate to stock quotes can also be used, for example in determining whether the wireless-device user would be interested in magazine subscription to a technology-related magazine. For example, if the wireless-device user is interested in stock quotes for a number of technology companies, the wireless-device user would probably also be interested in a magazine subscription that is for a technology-related magazine.

As shown by step 405 of FIG. 4, the response is coupled to the requesting service provider. That is, the response is provided to the entity or device that submitted the query in step 403. In one embodiment, each query submitted in step 403 must include information identifying the provider that submitted the query. This tells the wireless portal server where to send the response. With reference now to FIG. 1, for example, if a query is received (step 403) from service provider 140 of FIG. 1, wireless portal server 101 determines the response (step 404) and sends the response back to service provider 140 (step 405).

In one embodiment, to maintain security and privacy of wireless-device users 301, access is restricted to those service providers 320 who maintain specified security precautions. Also, in one embodiment, responses are encrypted before they are sent to prevent unauthorized usage.

In the present embodiment, the questions are determined in step 402 so as to maintain privacy safeguards while still providing answers to questions relating to wireless-device users. For example, a service provider could ask whether a particular wireless-device user would be likely to be interested in a magazine subscription for a technology-related magazine. The apparatus and method of the present invention allows for the analysis of confidential information available to the wireless portal server such as information from profile service 306, from session service 308 and information from providers 320 for determining a response. The response does not divulge the confidential information used for determining the response. Accordingly, the information needs of the requesting provider are met while maintaining confidentiality of any and all private information used to determine the response.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A portal server communicatively coupled with at least one wireless network, said portal server communicatively coupled to a plurality of service providers for providing content over channels of said portal server to wireless-device users, said portal server operable for providing a personalization service for personalization of services provided by said service providers.

2. The portal server of claim 1 wherein said portal server is a wireless portal server that comprises provision for said wireless-network user to enter static preferences, said personalization service utilizing said static preferences for said personalization of services by said service providers.

3. The portal server of claim 2 wherein said portal server is coupled to a data storage device, said portal server operable to store said static preferences in said data storage device.

4. The portal server of claim 1 wherein said portal server comprises a session service for storing session information relating to communication sessions between said wireless-device user and said service provider.

5. The portal server of claim 1 wherein said portal server comprises a software program that is operable to automatically determine answers to questions relating to said wireless-device user for personalization of services to be provided to said wireless-device user.

6. The portal server of claim 5 further comprising a personalization interface for coupling personalization queries from said service providers.

7. The portal server of claim 6 wherein said personalization interface comprises provision for receiving data from said service providers that can be used for personalization.

8. The portal server of claim 7 wherein said personalization interface is a Java Application Program Interface.

9. A method for providing personalization services using a portal server that is coupled to at least one wireless network, said method comprising:
specifying a plurality of questions relating to wireless-device users using an interface coupled to said portal server; and
upon receiving a query from a service provider that comprises at least one of said questions and that identifies a wireless-device user, determining a response to said question that predicts likely future behavior of said wireless-device user based on information available within a wireless application environment, and transmitting said response to said question to said service provider.

10. A method as recited in claim 9 wherein said response predicts likely future behavior of said wireless-device user based on information stored in said portal server.

11. A method as recited in claim 9 further comprising:
receiving information from said service provider relating to a wireless-device user.

12. A method as recited in claim 10 wherein said information from said service provider relating to a wireless-device user is used for determining said response.

13. A method as recited in claim 9 wherein said method further comprises:
receiving and storing static preference data from said wireless-device user; and
using said static preference data for determining said response.

14. A method as recited in claim 10 wherein said method further comprises:
receiving and storing session data relating to communication sessions with said wireless-device user; and
using said session data for determining said response.

15. A method as described in claim 14 wherein said method further comprises:
receiving and storing location data indicating the location of said wireless-device user, and
using said location data for determining said response.

16. In a computer system having a processor coupled to a bus, a computer readable medium coupled to said bus and having stored therein a computer program that when executed implements a method for providing personalization services using a portal server comprising:
specifying a plurality of questions relating to wireless-device users using an interface coupled to said portal server; and
upon receiving a query from a service provider that comprises at least one of said questions and that identifies a wireless-device user, determining a response to said question that predicts likely future behavior of said wireless-device user based on information available within a wireless application environment, and transmitting said response to said question to said service provider.

17. A computer-readable medium as recited in claim 16 wherein said response predicts likely future behavior of said wireless-device user based on information stored in said portal server.

18. A computer-readable medium as recited in claim 17 wherein said method further comprises:
receiving information from one of said service providers relating to a wireless-device user; and
using said information relating to said wireless-device user for determining said response.

19. A computer-readable medium as recited in claim 17 wherein said method further comprises:
receiving static preference data from said wireless-device user; and
using said static preference data for determining said response.

20. A computer-readable medium as recited in claim 18 wherein said method further comprises:
receiving and storing session data relating to communication sessions with said wireless-device user; and
using said session data for determining said response.

21. A computer-readable medium as recited in claim 17 wherein said method further comprises:
receiving and storing location data indicating the location of said wireless-device user, and
using said location data for determining said response.
